(19) United States
(12) Patent Application Publication
(10) Pub. No.: US 2003/0088814 A1
(43) Pub. Date: May 8, 2003

(54) Method and apparatus for logging file system operations

(76) Inventors: Ralph B. Campbell, San Jose, CA (US); Sushil Thomas, San Francisco, CA (US); Michael J. Byrne, Wicklow (IE); Jayadevi Sundararajan, Sunnyvale, CA (US)

Correspondence Address: PARK, VAUGHAN & FLEMING LLP, 508 SECOND STREET, SUITE 201, DAVIS, CA, 95616, US

(21) Appl. No.: 10/043,038

(22) Filed: Nov. 7, 2001

(51) Int. Cl. H04B 1/74

(52) U.S. Cl. 714/54

(57) ABSTRACT

One embodiment of the present invention provides a system that logs file system operations. Upon receiving a request to perform a file system operation, the system makes a call to an underlying file system to perform the file system operation. The system also logs the file system operation to a log on a log device to facilitate recovery of the file system operation in the event of a system failure before the file system operation is committed to non-volatile storage. In a variation on this embodiment, logging the file system operation involves storing an identifier for the file system operation to the log device. In one embodiment of the present invention, the system periodically commits the log to the underlying file system. This is accomplished by freezing ongoing activity on a file system, and making a call to the underlying file system to flush memory buffers to non-volatile storage. This causes outstanding file system operations to be committed to non-volatile storage. Next, the system removes outstanding file system operations from the log, and unfreezes the ongoing activity on the file system.

### BACKGROUND

1. Field of the Invention

The present invention relates to the design of file systems for computers. More specifically, the present invention relates to a method and an apparatus for logging file system operations without generating unnecessary disk accesses.

2. Related Art

One challenge in designing computer systems is to ensure that file system operations complete in a reliable manner. For performance reasons, a file system operation is typically applied to a portion of the file system which is copied to a file system cache located in volatile semiconductor memory. At a later point in time, the file system is “synchronized” by committing the file system cache to non-volatile storage. This synchronization operation may occur automatically at periodic time intervals or when the file system cache becomes full. Alternatively, synchronization may occur in response to an explicit file system call, such as the UNIX fsync( ) command. If the computer system fails before a file system operation is committed to non-volatile storage, no guarantee is made about whether or not the file system operation completes.

However, certain file system operations, such as directory modification operations, are guaranteed to be durable once the file system operation returns. They are also guaranteed to complete in order. These guarantees can be assured by synchronizing the file system so that file system operations are committed to non-volatile storage before any subsequent operations are performed. However, this synchronization process typically involves performing disk accesses, which can require millions of processor cycles to complete, and can hence greatly reduce computer system performance.

What is needed is a method and an apparatus for making certain file system operations durable and to assure they complete in order without the performance-limiting problems of performing synchronization operations.

### SUMMARY

One embodiment of the present invention provides a system that logs file system operations. Upon receiving a request to perform a file system operation, the system makes a call to an underlying file system to perform the file system operation. The system also logs the file system operation to a log that is located on a log device to facilitate recovery of the file system operation in the event of a system failure before the file system operation is committed to non-volatile storage. In a variation on this embodiment, logging the file system operation involves storing an identifier for the file system operation to the log device.

In one embodiment of the present invention, the system periodically commits the log to the underlying file system. This is accomplished by freezing ongoing user activity on the file system, and making a call to the underlying file system to write memory buffers to non-volatile storage. This causes outstanding file system operations to be committed to non-volatile storage. Next, the system removes outstanding file system operations from the log, and unfreezes the ongoing activity on the file system.

In one embodiment of the present invention, upon a subsequent computer system startup, the system examines the log within the log device, and replays any file system operations from the log that have not been committed to non-volatile storage.

In one embodiment of the present invention, the system checks for dependencies between the file system operation and ongoing file system operations. If such dependencies are detected, the system ensures that the file system operation and the ongoing file system operations complete in an order that satisfies the dependencies.

In one embodiment of the present invention, the request to perform the file system operation is received at a primary server in a highly available system, and the log device is located within a secondary server in the highly available system that acts as a backup for the primary server.

In one embodiment of the present invention, the system associates the file system operation with a transaction identifier for a set of related file system operations. During a subsequent logging operation, the system stores the transaction identifier along with the file system operation to the log device.

In one embodiment of the present invention, logging the file system operation involves determining if the file system operation belongs to a subset of file system operations that are subject to logging. If so, the system logs the file system operation. In a variation of this embodiment, the subset of file system operations are non-idempotent file system operations.

In one embodiment of the present invention, the log device stores the file system operation in volatile storage.

In one embodiment of the present invention, the log device stores the file system operation in non-volatile storage.

### BRIEF DESCRIPTION OF THE FIGURES

FIG. 1 illustrates a primary computer system and a secondary computer system in accordance with an embodiment of the present invention.

FIG. 2 is a flow chart illustrating the processing of a file system operation in accordance with an embodiment of the present invention.

FIG. 3 is a flow chart illustrating how entries are removed from the file system operation log in accordance with an embodiment of the present invention.

FIG. 4 is a flow chart illustrating how file system operations are recovered from the file system log in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer Systems

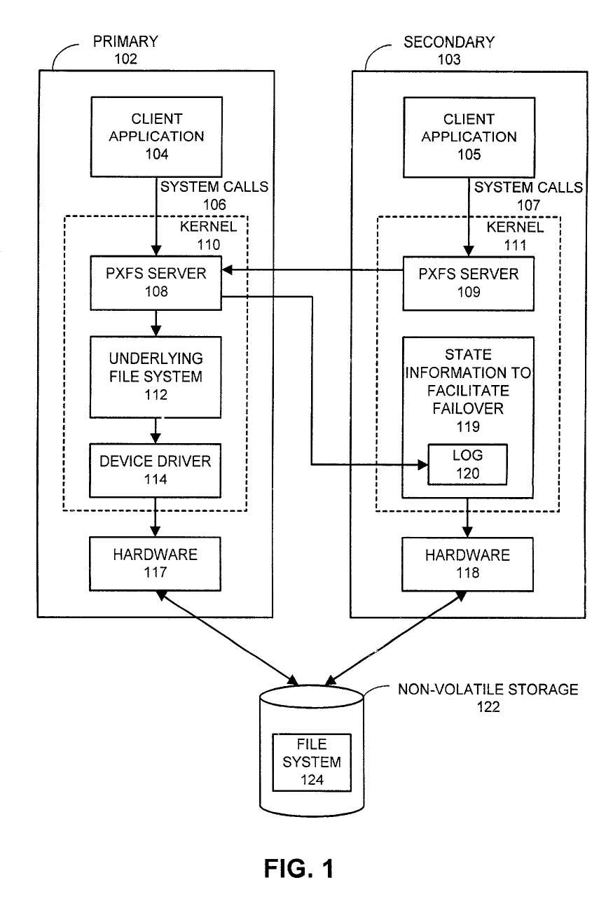

FIG. 1 illustrates a primary computer system 102 and a secondary computer system 103 in accordance with an embodiment of the present invention. Primary computer system 102 and secondary computer system 103 can generally include any type of computer system, including, but not limited to, a computer system based on a microprocessor, a mainframe computer, a digital signal processor, a portable computing device, a personal organizer, a device controller, and a computational engine within an appliance.

Primary computer system 102 and secondary computer system 103 are coupled to non-volatile storage 122, which contains a file system 124. Non-volatile storage 122 can include any type of system for storing data in non-volatile storage. This includes, but is not limited to, systems based upon magnetic, optical, and magneto-optical storage devices, as well as storage devices based on flash memory and/or battery-backed up memory.

Primary computer system 102 includes a client application 104 that makes system calls 106 to kernel 110. Note that client application 104 can reside on primary computer system 102, or alternatively on a remote computer system.

Similarly, secondary computer system 103 includes a client application 105 that makes system calls 107 to kernel 111. Client application 105 can reside on secondary computer system 103, or alternatively on a remote computer system. In one embodiment of the present invention, this remote computer system is another node in a cluster of computer systems, possibly without a direct connection to non-volatile storage 122.

File system calls from client application 104 are directed to proxy file system (PXFS) server 108 located within kernel 110. PXFS server 108 passes these file system calls down to underlying file system 112. Underlying file system 112 can include any type of file system that can receive high-level file system calls, such as a UNIX file system. Underlying file system 112 communicates through device driver 114 with hardware 117, which communicates with non-volatile storage 122.

File system calls from client application 105 are directed to PXFS client 109 within kernel 111. PXFS client 109 forwards the file system calls to PXFS server 108 located on primary computer system 102. PXFS server 108 handles these file system requests in the same manner as file system requests from client application 104. From the viewpoint of client application 105, system calls directed to PXFS client 109 are transparently forwarded to PXFS server 108 on primary computer system 102.

PXFS server periodically logs state information to log 120 within secondary computer system 103. Note that log 120 is part of the state information 119 that is maintained within secondary computer system 103 to facilitate failovers from primary computer system 102. Note that log 120 generally includes an associated lock.

If primary computer system 102 fails, a “failover” operation is initiated, which causes secondary computer system 103 to take ever for primary computer system 102. This failover operation is made possible by periodically moving state information from primary computer system 102 to secondary computer system 103, so that secondary has enough information to take over from primary computer system 102 when primary computer system 102 fails. Secondary computer system 103 needs only enough information to recover operations seen by surviving computer systems. Hence, when primary computer system 102 crashes, a partially completed operation that has not been communicated to other computer systems does not have to be completed.

Note that although the present invention is described in the context of primary computer system 102 that supports failovers to a secondary computer system 103, the present invention is not meant to be limited to highly available computer systems. In general, the present invention can be applied to any computer system that operates on files. Although note that it is desirable to have a log device that is separate from primary computer system 102 so that a failure of primary computer system 102 does not cause a corresponding failure of the log device.

Processing a File System Operation

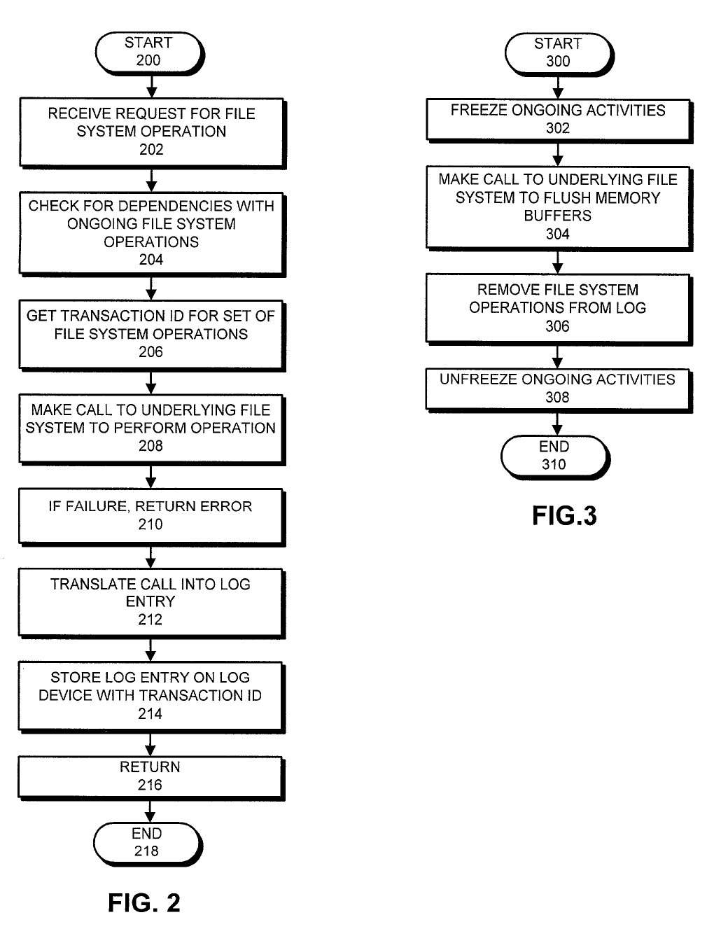

FIG. 2 is a flow chart illustrating the processing of a file system operation in accordance with an embodiment of the present invention. The system starts by receiving a request for a file system operation (step 202). For example, PXFS server 108 can receive a system call that contains a request for a file system

Next, the system returns the system call back to client application 104 (step 216). This allows client application 104 to continue operating as if the file system operation were committed to non-volatile storage 122.

In one embodiment of the present invention, the system only checkpoints a subset of file system operations that are non-idempotent, which means that the file system operations cannot be repeated without causing problems. For example, in one embodiment of the present invention, the system checkpoints file/directory operations such as create, remove, link, symbolic link, rename, make directory and remove directory.

Note that by checkpointing the file system operations, the file system operations can be replayed, if necessary, by making calls to the underlying file system. Furthermore, this type of checkpoint is much more compact than a checkpoint for a conventional logging system that logs actual changes to disk blocks.

Removing Entries for the File Operation Log

FIG. 3 is a flow chart illustrating how entries are removed from the file system operation log 120 in accordance with an embodiment of the present invention. The process illustrated in FIG. 3 can take place at periodic intervals or when log 120 becomes full.

The system first freezes ongoing activities to the file system (step 302). This can be accomplished by delaying new requests to the combined log/underlying file system. Next, the system makes a call to the underlying file system to write memory buffers to non-volatile storage 122 (step 304). In one embodiment of the present invention, the system makes an fsync( ) system call to flush the memory buffers. When the memory buffers are flushed, all uncompleted file system operations are committed to disk. At this point, the system removes the file system operations from log 120 (step 306), and unfreezes ongoing activities to allow new requests to be processed (step 308).

Recovering File System Operations from the File Operation Log

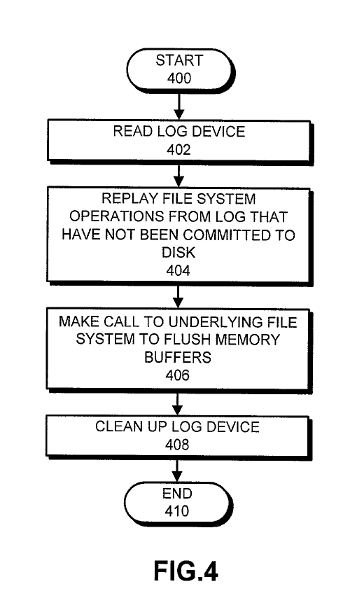

FIG. 4 is a flow chart illustrating how file system operations are recovered from the file system log in accordance with an embodiment of the present invention. After a failure of primary 102, secondary 103 reads log 120 (step 402). Next, secondary 103 replays any file system operations in log 120 that have not been committed to non-volatile storage 122 (step 404). This involves performing operations stored in log 120 that make calls to the underlying file system, so that the secondary 103 performs the same operations in the same order as primary 102 did.

The system then makes a call to the underlying file system 112 to flush memory buffers that the underlying file system may be using (step 406), and cleans up the log device by freeing space within the log for file system operations that have been committed to non-volatile storage 122 (step 408). At this point, the system is able to commence execution from the point where the failure occurred.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for logging file system operations, comprising:
receiving a request to perform a file system operation;
making a call to an underlying file system to perform the file system operation; and
logging the file system operation to a log within a log device to facilitate recovery of the file system operation in the event of a system failure before the file system operation is committed to non-volatile storage.

2. The method of claim 1, wherein logging the file system operation involves storing an identifier for the file system operation to the log device.

3. The method of claim 1, further comprising periodically committing the log to the underlying file system by:
freezing ongoing activity on a file system;
making a call to the underlying file system to flush memory buffers to non-volatile storage, whereby outstanding file system operations are guaranteed to be committed to non-volatile storage;
removing outstanding file system operations from the log; and
unfreezing the ongoing activity on the file system.

4. The method of claim 1, wherein upon a subsequent computer system startup, the method further comprises:
examining the log within the log device;
replaying any file system operations from the log that have not been committed to non-volatile storage.

5. The method of claim 1, further comprising checking for dependencies between the file system operation and ongoing file system operations; and
if dependencies are detected, ensuring that the file system operation and the ongoing file system operations complete in an order that satisfies the dependencies.

6. The method of claim 1,
wherein the request to perform the file system operation is received at a primary server in a highly available system; and
wherein the log device includes a secondary server in the highly available system that acts as a backup for the primary server.

7. The method of claim 1, further comprising:
associating the file system operation with a transaction identifier for a set of related file system operations; and
wherein logging the file system operation involves storing the file system operation with the transaction identifier to the log device.

8. The method of claim 1, wherein logging the file system operation involves:
determining if the file system operation belongs to a subset of file system operations that are subject to logging; and
if so, logging the file system operation.

9. The method of claim 8, wherein the subset of file system operations are non-idempotent file system operations.

10. The method of claim 1, wherein the log device stores the file system operation in volatile storage.

11. The method of claim 1, wherein the log device stores the file system operation in non-volatile storage.

12. A computer-readable storage medium storing instructions that when executed by a computer cause the computer to perform a method for logging file system operations, the method comprising:
receiving a request to perform a file system operation;
making a call to an underlying file system to perform the file system operation; and
logging the file system operation to a log within a log device to facilitate recovery of the file system operation in the event of a system failure before the file system operation is committed to non-volatile storage.

13. The computer-readable storage medium of claim 12, wherein logging the file system operation involves storing an identifier for the file system operation to the log device.

14. The computer-readable storage medium of claim 12, wherein the method further comprises periodically committing the log to the underlying file system by:
freezing ongoing activity on a file system;
making a call to the underlying file system to flush memory buffers to non-volatile storage, whereby outstanding file system operations are guaranteed to be committed to non-volatile storage;
removing outstanding file system operations from the log; and
unfreezing the ongoing activity on the file system.

15. The computer-readable storage medium of claim 12, wherein upon a subsequent computer system startup, the method further comprises:
examining the log within the log device;
replaying any file system operations from the log that have not been committed to non-volatile storage.

16. The computer-readable storage medium of claim 12, wherein the method further comprises checking for dependencies between the file system operation and ongoing file system operations; and
if dependencies are detected, ensuring that the file system operation and the ongoing file system operations complete in an order that satisfies the dependencies.

17. The computer-readable storage medium of claim 12,
wherein the request to perform the file system operation is received at a primary server in a highly available system; and
wherein the log device includes a secondary server in the highly available system that acts as a backup for the primary server.

18. The computer-readable storage medium of claim 12, wherein the method further comprises:
associating the file system operation with a transaction identifier for a set of related file system operations; and
wherein logging the file system operation involves storing the file system operation with the transaction identifier to the log device.

19. The computer-readable storage medium of claim 12, wherein logging the file system operation involves:
determining if the file system operation belongs to a subset of file system operations that are subject to logging; and
if so, logging the file system operation.

20. The computer-readable storage medium of claim 19, wherein the subset of file system operations are non-idempotent file system operations.

21. The computer-readable storage medium of claim 12, wherein the log device stores the file system operation in volatile storage.

22. The computer-readable storage medium of claim 12, wherein the log device stores the file system operation in non-volatile storage.

23. An apparatus that logs file system operations, comprising:
a receiving mechanism that is configured to receive a request to perform a file system operation;
a calling mechanism that is configured to make a call to an underlying file system to perform the file system operation; and
a logging mechanism that is configured to log the file system operation to a log within a log device to facilitate recovery of the file system operation in the event of a system failure before the file system operation is committed to non-volatile storage.

24. The apparatus of claim 23, wherein the logging mechanism is configured to store an identifier for the file system operation to the log device.

25. The apparatus of claim 23, wherein the logging mechanism is configured to periodically:
freeze ongoing activity on a file system;
make a call to the underlying file system to flush memory buffers to non-volatile storage, whereby outstanding file system operations are guaranteed to be committed to non-volatile storage;
remove outstanding file system operations from the log; and to
unfreeze the ongoing activity on the file system.

26. The apparatus of claim 23, further comprising a recovery mechanism that operates during system startup, wherein the recovery mechanism is configured to:
examine the log within the log device; and to
replay any file system operations from the log that have not been committed to non-volatile storage.

27. The apparatus of claim 23, further comprising a dependency handler that is configured to:
check for dependencies between the file system operation and ongoing file system operations; and to
ensure that the file system operation and the ongoing file system operations complete in an order that satisfies dependencies if dependencies are detected.

28. The apparatus of claim 23,
wherein the receiving mechanism is located within a primary server in a highly available system; and
wherein the log device is located within a secondary server in the highly available system that acts as a backup for the primary server.

29. The apparatus of claim 23, further comprising a transaction mechanism that is configured to associate the file system operation with a transaction identifier for a set of related file system operations; and
wherein the logging mechanism is configured to log the file system operation with the transaction identifier to the log device.

30. The apparatus of claim 23, wherein the logging mechanism is configured to:
determine if the file system operation belongs to a subset of file system operations that are subject to logging; and to
log the file system operation if the file system operation belongs to the subset of file system operations that are subject to logging.

31. The apparatus of claim 30, wherein the subset of file system operations are non-idempotent file system operations.

32. The apparatus of claim 23, wherein the log device is configured to store the file system operation in volatile storage.

33. The apparatus of claim 23, wherein the log device is configured to store the file system operation in non-volatile storage.
